(19) United States
(12) Patent Application Publication
(10) Pub. No.: US 2011/0175928 A1
(43) Pub. Date: Jul. 21, 2011

(54) Map Display Device and Map Display Method

(75) Inventor: Daisuke HASHIMOTO, Tokyo (JP)

(73) Assignee: Clarion Co., Ltd., Tokyo (JP)

(21) Appl. No.: 12/912,149

(22) Filed: Oct. 26, 2010

(30) Foreign Application Priority Data
Jan. 18, 2010 (JP) 2010-008213

(51) Int. Cl. G09G 5/00

(52) U.S. Cl. 345/629

(57) ABSTRACT

A map display device, including a map display control unit that causes a map to be displayed on a display monitor and causes a facility icon to be displayed being superimposed on a map; an indication unit that indicates a portion of an area of a map displayed on the display monitor; a specification unit that specifies a facility icon existing in an indicated area indicated by the indication unit from among facility icons displayed on the display monitor; and a changer that changes a display mode of a specified facility icon specified by the specification unit into a display mode in which a visibility of image information on a map is not disturbed.

### INCORPORATION BY REFERENCE

The disclosure of the following priority application is herein incorporated by reference: Japanese Patent Application No. 2010-008213 filed Jan. 18, 2010.

### BACKGROUND OF THE INVENTION

1. Field of the Invention

The present invention relates to a map display device and a map display method.

2. Description of Related Art

There is a navigation device known in the related art that displays icons showing the positions of facilities and the like on a map displayed on a display device (for example, Japanese Laid Open Patent Publication No. 2007-303878).

In order to prevent the visibility of a map from deteriorating due to closely spaced facility icons, the navigation device disclosed in Japanese Laid Open Patent Publication No. 2007-303878 gives priorities to facility icons using a predetermined algorithm so that the low-priority facility icons are not displayed.

### SUMMARY OF THE INVENTION

However, the navigation device of patent reference literature 1 often fails to hide a facility icon superimposed on a map area on which the user desires to obtain information. In this case, the user fails to obtain necessary information on the map screen.

According to the 1st aspect of the present invention, a map display device comprises: a map display control unit that causes a map to be displayed on a display monitor and causes a facility icon to be displayed being superimposed on a map; an indication unit that indicates a portion of an area of a map displayed on the display monitor; a specification unit that specifies a facility icon existing in an indicated area indicated by the indication unit from among facility icons displayed on the display monitor; and a changer that changes a display mode of a specified facility icon specified by the specification unit into a display mode in which a visibility of image information on a map is not disturbed.

According to the 2nd aspect of the present invention, in a map display device according to the 1st aspect, it is preferred that until the indicated area is indicated by the indication unit, the map display control unit causes a facility icon displayed on the display monitor to be displayed in a display mode in which the facility icon masks a map.

According to the 3rd aspect of the present invention, in a map display device according to the 1st aspect, it is preferred that a display mode of the specified facility icon is any of a mode in which the specified facility icon is displayed translucent, a mode in which the specified facility icon is displayed blinking, and a mode in which the facility icon is hidden.

According to the 4th aspect of the present invention, a map display device according to the 1st aspect further comprises: an icon discriminator that discriminates a facility icon that overlaps with a road of a map from a facility icon that does not overlap therewith among the specified facility icons, wherein: the changer changes a display mode only of a facility icon that overlaps with a road among the specified facility icons into a display mode in which a road superimposed with the facility icon can be identified.

According to the 5th aspect of the present invention, in a map display device according to the 4th aspect, it is preferred that based upon a size of the specified facility icon, a distance from the specified facility icon to a neighborhood road, and a scale of a map displayed on the display monitor, the icon discriminator distinguishes whether the specified facility icon overlaps with the road.

According to the 6th aspect of the present invention, a map display device according to the 1st aspect further comprises: a touch screen that is built into the display monitor; a map scrolling unit that, when a touch screen on the display monitor is pressed, scrolls a map in a touch scroll mode in which a map is scrolled so that the pressed position becomes a center of a screen, and a disable instruction output unit that outputs an instruction to disable an operation of the map scrolling unit, wherein: the indication unit sets the indicated area based upon a position touched on the touch screen while a disable instruction is being output from the disable instruction output unit.

According to the 7th aspect of the present invention, in a map display device according to the 1st aspect further comprises: a character discriminator that discriminates a character that overlaps with the road of a map from a character that does not overlap therewith among characters displayed in the designated area; and a character display control unit that causes the character that overlaps with the road of a map to be displayed in a display mode in which a road that is superimposed with the character can be identified when a character is displayed being superimposed on the map.

According to the 8th aspect of the present invention, in a map display device according to the 7th aspect, it is preferred that a display mode of the character that overlaps with the road is any of a mode in which the character overlapping with the road is displayed translucent, a mode in which the character overlapping with the road is displayed blinking, and a mode in which the character overlapping with the road is hidden.

According to the 9th aspect of the present invention, in a map display device according to the 1st aspect, it is preferred that when any position on a map displayed on the display monitor is indicated by a user, the indication unit indicates a predetermined range around the position as the indicated area.

According to the 10th aspect of the present invention, a map display method includes: a first step in which a map is displayed on a display monitor and a facility icon is displayed being superimposed on a map; a second step in which a part of an area of a map displayed on the display monitor is indicated; a third step in which a facility icon existing in an area indicated in the second step is specified from among facility icons displayed on the display monitor; and a fourth step in which, a display mode of the specified facility icon specified in the third step is changed into a display mode in which a visibility of image information on a map is not disturbed.

According to the 11th aspect of the present invention, in a map display method according to the 10th aspect, it is preferred that in the first step, the facility icon is displayed in a display mode in which a map portion that is superimposed with the facility icon is hidden; and in the fourth step, the specified facility icon is displayed in a display mode in which a map that is superimposed with the specified facility icon can be identified.

According to the 12th aspect of the present invention, a map display method according to the 10th aspect further includes: a step in which a facility icon that overlaps with a road of a map and a facility icon that does not overlap therewith are discriminated among the specified facility icons, wherein: in the fourth step, among the specified facility icons, only a facility icon that is superimposed on a road is displayed in a display mode in which a map that is superimposed with the facility icon can be identified.

### BRIEF DESCRIPTION OF THE DRAWINGS

FIG. 1 is a block diagram showing the structure of the navigation device in an embodiment of the present invention.

FIGS. 2A and 2B are figures for explanation of drawing of image data of a map.

FIG. 3 is a flowchart for explanation of the map display processing in an embodiment of the present invention.

FIG. 4 is a figure for explanation of display of icons in an embodiment of the present invention.

FIG. 5 is a flowchart for explanation of a variation of the map display processing in an embodiment of the present invention.

FIG. 6 is a figure for explanation of X in the step S204 and Z in the step S205 of FIG. 5.

FIG. 7 is a figure for explanation of a variation of display of icons in an embodiment of the present invention.

### DESCRIPTION OF PREFERRED EMBODIMENTS

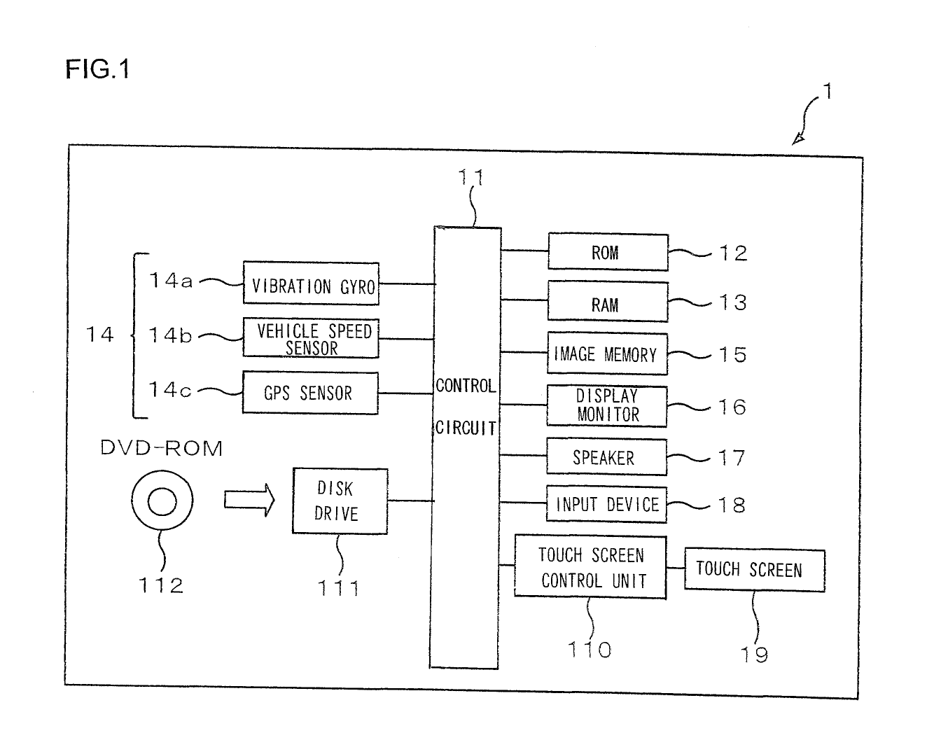

FIG. 1 shows a navigation device 1 according to an embodiment of the present invention. The navigation device 1 causes a facility icon to be displayed on a display monitor so as to indicate the positions of a variety of facilities (referred to as POI) such as a convenience store and a service station. The map display device according to the present invention includes a function to improve map visibility, where a map of prior art navigation device shows a low visibility due to a plurality of superimposed facility icons.

The navigation device 1 includes a control circuit 11, a ROM 12, a RAM 13, a current position detection device 14, an image memory 15, a display monitor 16, a speaker 17, an input device 18, a touch screen 19, a touch screen control unit 110, and a disk drive 111. A DVD-ROM 112 upon which map data is stored is loaded in the disk drive 111. It is to be noted that the map data may be read out from some other recording media other than the DVD-ROM 112, such as, for example, a CD-ROM, a hard disk, or the like.

The control circuit 11 is constituted with a micro processor and its peripheral circuitry, and, using the RAM 13 as a work area, it performs various types of controls by executing a control program which is stored in the ROM 12. In addition, the control circuit 11 performs predetermined route search processing based upon the map data stored in the DVD-ROM 112. Then, the processing result is displayed on the display monitor 16 as a recommended route.

It is to be noted that it may also be arranged that the control program is provided to the navigation device 1 via a recording medium such as a DVD-ROM similar to the DVD-ROM 112, and is stored in the RAM 13 or a rewritable non-volatile memory (not shown in the figure) in the navigation device 1, and used. In addition, it may also be arranged that the control program is provided on a data signal from a center (not shown in the figure) the navigation device 1 via a mobile phone (not shown in the figure) or the like. In this manner, the control program executed by the navigation device 1 may also be supplied in the form of a computer-readable computer program product in various formats, such as a recording medium or a data signal.

The current position detection device 14 is a device that detects the current position of the vehicle. The current position detection device 14 is constituted with a vibrational gyroscope 14a, a vehicle speed sensor 14b, a GPS sensor 14c, and the like. The vehicle turning angle is detected by the vibrational gyroscope 14a and the vehicle speed is detected by the vehicle speed sensor 14b. The direction of travel of the vehicle is calculated based upon the turning angle detected by the vibrational gyroscope 14a and the travel distance of the vehicle is calculated based upon the vehicle speed detected by the vehicle speed sensor 14b. A GPS signal from a GPS satellite is received by the GPS sensor 14c. The longitude and latitude, which is geographical position information of the vehicle, is calculated by the GPS sensor 14c. The current position detection device 14 calculates the current position of the vehicle based upon the longitude and latitude of the vehicle, the vehicle travel distance, and the vehicle travel direction, which are calculated as above. Based upon the current position of the vehicle calculated by the current position detection device 14, the navigation device 1 determines the display range of the map, the route search starting point, and the like and causes a position mark of the vehicle to be displayed at the current position on the map.

Map data stored in the DVD-ROM 112 includes data for map display, data for route search, and the like. The data for map display and the data for route search include link information and node information of the roads stored in the map data. The data for map display includes map data of a plurality of scales from wide-area to detail. The scale of the displayed map can be modified in accordance with the demand of the user.

The link information and the node information will be explained with an example of two adjacent intersections. The two adjacent intersections are defined by a start point node including information of one intersection, a terminal node including information of the other intersection, and a link including information of the road that connects the intersections defined by the start point node and the terminal node. The position coordinates (coordinates substantially indicating the longitude and latitude) of the intersections are each stored as position data of the start point node and the terminal node. The link connecting the both nodes is managed by number. An interpolation node is provided between the start point node and the terminal node in the event that the road connecting the adjacent intersections includes a curve with equal to or greater than a specified radius of curvature or an unusual shape. The interpolation node also includes position data.

Facility data is also stored in the DVD-ROM 112. The facility data is the data related to facilities, which are classified according to categories such as service stations, restaurants, etc. The facility data includes position data indicating the position of a facility, address data and telephone number data, and the like. The facility data is tabled for each of the classified categories. The facility icons are displayed on the map in respective display modes assigned to the categories.

Map image data for displaying a map on the display monitor 16 is stored in the image memory 15. The map image data is timely generated by the control circuit 11 based upon the map data stored in the DVD-ROM 112.

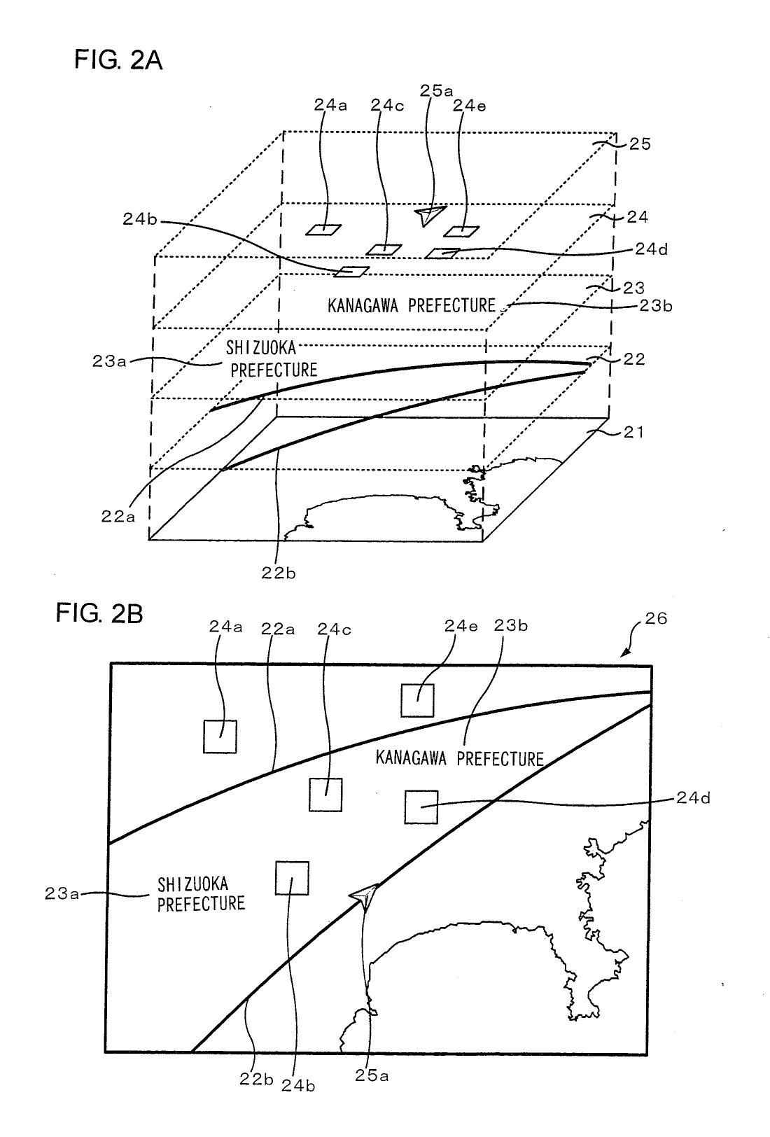

The map image data will be explained with reference to FIGS. 2A and 2B. The map image data is generated by superimposing image data of five layers 21 to 25 shown in FIG. 2A. The image data of each of the five layers is drawn in a work area assigned to each layer in the RAM 13 of the control circuit 11. The background of the map is drawn on the first layer 21 based upon background data read out from the map data, and roads 22a and 22b are drawn on the second layer 22 based upon road data read out from the map data. Characters 23a and 23b are drawn on the third layer 23 based upon character data read out from the map data, and icons 24a to 24e are drawn on the fourth layer 24 based upon the facility data read out from the map data. A vehicle position mark 25a is drawn on the fifth layer 25 at the calculated current position on the map. Then, as shown in FIG. 2B, composite image data 26 for display, generated by superimposing the first layer 21, the second layer 22, the third layer 23, the fourth layer 24, and the fifth layer 25 in order on top, is stored in the image memory 15.

Based upon the generated map image data, a variety of information such as a map of the area near the vehicle is displayed on the display monitor 16. Through the speaker 17, a voice for instructing the user to perform a variety of input operations and guiding the route is output. The input device 18, which is an operation device with which the user sets a variety of commands, inputs search criteria, and the like, is realized by button switches on the operation panel, hardware switches around the panel, and the like.

The touch screen 19 is equipped with transparent touch switches to be layered on the surface of the display monitor 16, through which an image to be displayed on the display monitor 16 is transmitted. The touch screen 19 sends out a signal in accordance with the operation position on the touch screen 19 to the touch screen control unit 110. Then, the touch screen control unit 110 calculates the position at which the touch screen 19 was touched. Upon touching on the display screen of the display monitor 16, processing defined in a variety of buttons and display menus which are touched is executed.

In the navigation device 1 configured as above, when a destination is set by the user with a known input operation, a route calculation to the destination is performed, based upon a predefined algorithm, with the current position detected by the current position detection device 14 as the departure point. The route obtained in this manner (hereinafter referred to as a recommended route) is displayed on the screen to be distinct from other routes by changing the display mode, for instance, display color or the like. This allows the user on the screen to recognize the recommended route on the map. In addition, the navigation device 1 gives the user an instruction of the direction of travel via the screen, the voice, or the like so as to guide the vehicle along the route, by which the vehicle can travel in accordance with the recommended route.

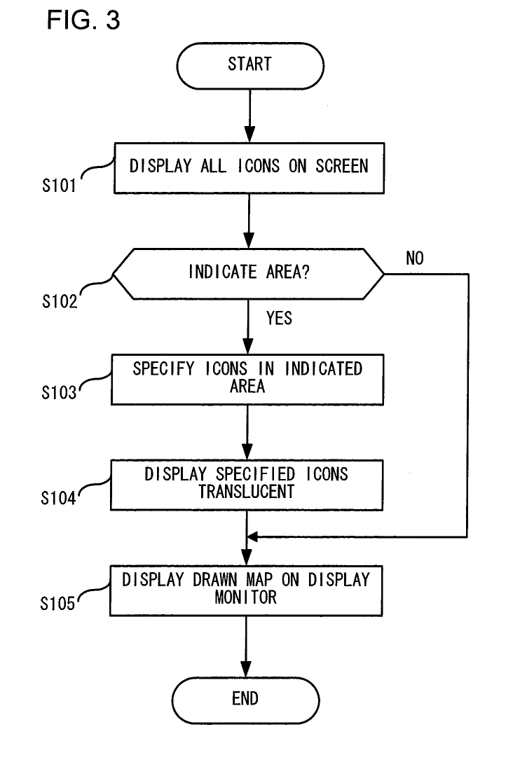

Next, the map display processing of the navigation device in an embodiment of the present invention will now be explained with reference to the flowchart of FIG. 3. The flowchart of FIG. 3 relates to the processing for achieving a function to improve the visibility of the map on which a plurality of facility icons are superimposed, and other processing procedures therein to be executed by the navigation device are omitted.

A mode related to map scrolling and that related to display/hide of an icon in the navigation device of the present embodiment will be explained prior to explanation of the processing procedure by the flowchart of FIG. 3.

—Mode Related to Map Scrolling—

In the navigation device of the present embodiment, any one of a touch scroll mode and a joystick scroll mode can be selected as a map scroll mode on the menu screen. In the event that the touch scroll mode is selected, pressing any position on the display monitor causes the map to scroll so that the pressed position becomes the screen central position. In the event that the joystick scroll mode is selected, a tilt operation of the joystick in eight directions, the map scrolls in the direction according to the tilt operation.

In this embodiment even in the event that the touch scroll mode is selected, the map scrolling that moves the touched position to the center can be prohibited by an operation to disable scrolling. In the present embodiment, as described later, the control circuit 11 sets an area of a predetermined size (range) around the indicated position in response to an operation of the user to indicate any position on the display monitor. In the event of performing area setting procedure in this manner, it is necessary to temporarily block the touch scroll mode by performing a scroll disable operation. In the navigation device of the present embodiment, a scroll disable button is displayed on the screen and, the touch scroll mode is temporarily halted by pressing this button. In other words, scrolling is disabled when the touch screen is pressed while the scroll disable button is operated.

—Mode Related to Icon Display—

In the navigation device of the present embodiment, an icon display mode, in which a facility icon is always displayed, and an icon hide mode, in which a facility icon is always hidden, can be selected on the menu screen. In the event that the icon hide mode is selected, all the facility icons are blocked to be displayed. In the event that the icon display mode is selected, facility icons of a predetermined category are displayed. For instance, if “convenience store” has been selected as a category of facilities, a convenience store icon (facility icon) of a design assigned to a convenience store is displayed.

In the event that the icon display mode is selected, pressing the touch screen while performing a scroll disable operation causes a specified area around the pressed position to be set. Then, those facility icons positioned in the area are displayed in a translucent mode in order to prevent the visibility of the map including roads from deteriorating.

The processing of FIG. 3 is executed by the control circuit 11 according to a program that starts in a condition that the touch scroll mode and the icon display mode, as described above, have been set.

In a step S101, the control circuit 11 searches a facility located in the neighborhood of the vehicle position regarding facilities of a predetermined category. The displayed design of a facility icon is determined in each category of the facilities, and the facility icon is displayed at the position with the longitude and latitude of the searched facility. In a step S102, the control circuit 11 makes a decision as to whether or not an area has been indicated. When a signal showing that a scroll disable operation button has been operated and a touched position signal showing that any position of the touch screen has been pressed are input, the control circuit 11 makes a decision that an area has been indicated.

After making a decision that an area has been indicated, the control circuit 11 specifies facility icons in the area in a step S103. Among all the searched facilities, those having the position information with the longitudes and latitudes in the indicated area are specified as the facility icons in the area. In a step S104, the control circuit 11 performs image processing so as to display the specified facility icons translucent. In other words, all the facility icons displayed on the screen before indication of the area are all opaque and therefore it is in a display mode that the icons are masking the map. The display mode is changed so that the facility icons in the area are displayed translucent when the area is indicated. It is to be noted that translucent processing for a facility icon is well-known processing and therefore explanation thereof is omitted.

In a step S105, the control circuit 11 draws the searched facility icons for displaying them on the display monitor 16. The facility icons in the indicated area are displayed translucent so that the map is visible. The facility icons outside the indicated area are displayed in a mode in which the icons mask the map.

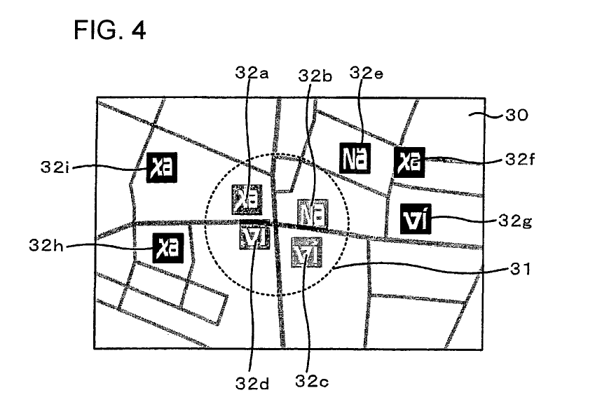

An example of a display mode of facility icons inside and outside the indicated area will be explained with reference to FIG. 4. Facility icons 32a to 32d inside an indicated area 31 are all displayed translucent and facility icons 32e to 32i outside the indicated area 31 are displayed opaque. Thus, the visibility of the map in the area 31 indicated by the user is improved.

It is to be noted that facility icons “XA”, “NA”, and “VI” of FIG. 4 are facilities respectively belong to category types which are different from each other. It is to be noted that these three categories are provided in the icon display mode of the menu screen in advance.

The following operations and advantageous effects can be achieved by the navigation device of the embodiment explained above.

(1) It is arranged that the display mode of a facility icon in the area indicated by the user is changed into a display mode in which the map portion masked by the facility icon becomes visible, thereby facilitating recognition of graphics on the map for which the user desires to obtain information.

For example, the facility icons displayed in opaque style, which mask the map until indication of the area, are displayed in other styles such as translucent, blinking, or non-displaying within the indicated area, after the area is indicated. As a result, the facility icons are prevented from masking a road and a variety of character information on the map and thus the visibility of the map is prevented from deteriorating.

(2) It is arranged that the indication area can be set by the user around any desired position on the screen, thereby assuring the user to view the map or the road that he particularly desires to view or confirm.

(3) Since it is sufficient only to press the touch screen for indicating the area, the area indication is easy.

(4) Since it is arranged so that it can be operated to suspend the touch scrolling the time of area indication operation, the processing to set the facility icons translucent can be performed instead of scroll processing even in the event that the touch scroll mode has been set.

(5) When an area is indicated on the map screen on which a plurality of facility icons are displayed, the display mode of the facility icons within the area are changed, thereby improving the visibility of the facility icons in the area indicated by the user even if the number of the facility icons increases.

The above embodiments can be varied as follows.

(1) Although in the above embodiment all the facility icons in the indicated area are displayed translucent, they may also be displayed blinking. The display mode of the facility icons may be one in which a road or the map behind the facility icons is visible. Therefore, the facility icons in the area may be treated not to be shown.

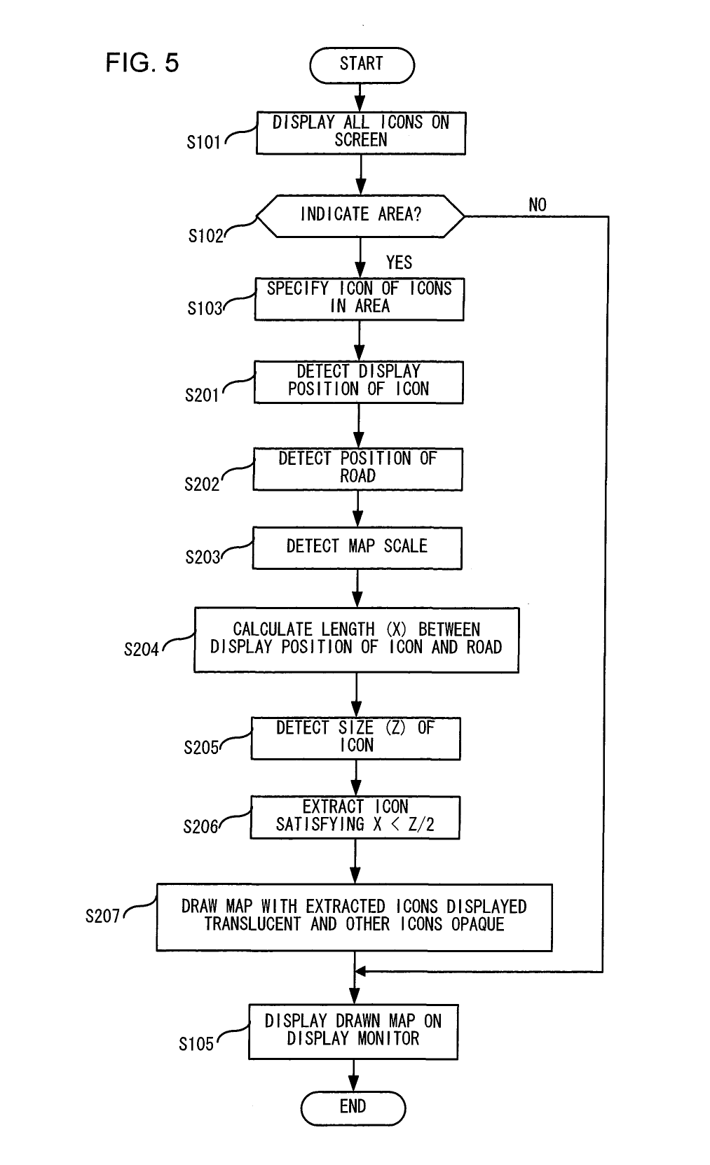

(2) It may also be arranged that only facility icons superimposed on a road in the indicated area are displayed translucent. FIG. 5 is a flowchart showing the procedure of this type of variation. The same reference numerals are assigned to the same steps as those in the flowchart of FIG. 3 so that their description will be curtailed.

After the facility icons in the area are specified in the processing from the step S101 to the step S103, the flow of control proceeds to a step S201.

In the step S201, the display position of the facility icons in the indicated area are detected. The display positions of the facility icons are detected based upon position data of the facility data described above. In a step S202, the positions of roads in the indicated area are detected. The positions of the roads are detected based upon link information and node information of the roads stored in the map data. In the step S203, a map scale to be displayed on the display monitor 16 is detected.

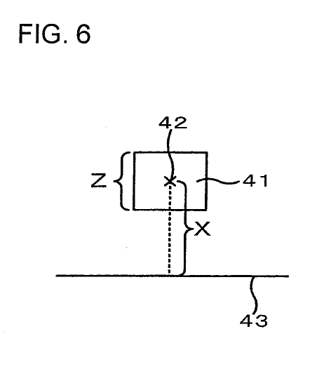

In a step S204, based upon the display position of the facility icons detected in the step S201, the positions of the roads detected in the step S202, and the map scale detected in the step S203, the respective lengths Xs on the display screen between the respective facility icons displayed in the designated area and the roads in the indicated area are calculated. With reference to FIG. 6, for instance, when a perpendicular line drawn from an icon display position 42, which is the central position of a facility icon 41, to an adjacent road 43, the length X from the icon display position to the point of intersection with the road is calculated. In a step S205, a size Z of the facility icon 41 (with reference to FIG. 6) displayed on the map is detected. The size of the facility icon is constant regardless of the scale and predefined. It is to be noted that the facility icons are not displayed in a wide-scale map display of the predetermined scale.

In a step S206, a facility icon that satisfies X<Z/2 is extracted from among the facility icons displayed in the designated area. The facility icons extracted in the step S206 are the facility icons that overlap with the road. In a step S207, the map is drawn with the facility icon extracted in the step S206 displayed translucent and the other facility icons displayed opaque. The drawing of the map is performed by, as shown in FIG. 2A, drawing images on the first to fifth layers 21 to 25, overlapping the images drawn on the first to fifth layers 21 to 25 so as to generate image data 26, and storing this image data 26 in the image memory 15. In the step S105, the map drawn as above is displayed on the display monitor 16.

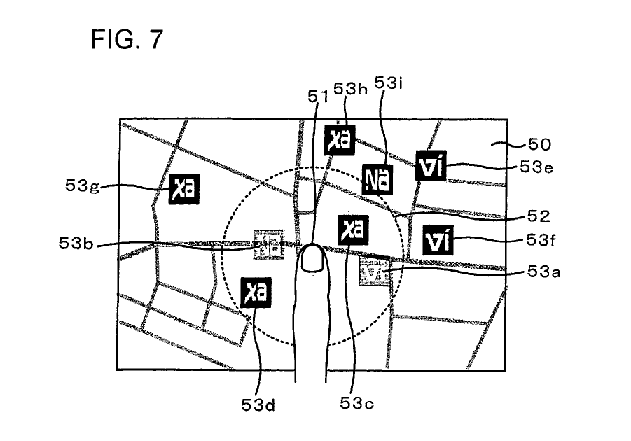

According to the above icon display procedure, as shown in FIG. 7, among facility icons 53a to 53d positioned in an indicated area with circle 52 defined with a predetermined length of radius from a touched position 51, only the facility icons 53a and 53b, which overlap with the road, are displayed translucent in the event that the user touches a map 50.

The following operations and advantageous effects can be achieved by the navigation device 1 according to the above variation.

In the area 52 indicated by the user, the facility icons 53a to 53i are displayed being superimposed on the map 50. It is arranged that among the facility icons 53a to 53i, the facility icon 53a and 53b, which are displayed superimposing on the road, are displayed translucent so that the user can recognize the portions of the roads or map where the facility icons are superimposed. In other words, the display mode is changed. As a result, the visibility of the roads can be improved in the area in which the visibility was deteriorated due to increased number of facility icons.

(3) Although in the above variation, among facility icons located in the indicated area, the facility icons superimposed on the map undergo the translucent processing in order to avoid deteriorating the visibility of the map, they may also be displayed blinking Alternatively, it may also be arranged that the facility icons to be superimposed on the road are not displayed.

(4) In the above explanations of the embodiment and the variation, the case in which the touch scroll mode is set is described. In the event that the joystick scroll mode is set, a designated area is set by pressing the touch screen without performing a scroll disable operation.

(5) Although it is arranged that in the navigation device of the above embodiment the touch scroll mode is disabled when the touch screen is pressed while pressing a touch scroll disable button displayed on the screen, an operation to disable the touch scroll mode is not limited to this operation of the disable button.

(6) In the above embodiment, a circular area of a predetermined radius around the touched position on the touch screen is set as the designated area. However, setting of a designated area is not limited to such an operation. For instance, a rectangular area around a touched position may be set as a designated area. In the event that the joystick scroll mode is set, a rectangular area around the position indicated using the joystick is set as a designated area. In addition, a desired area may also be indicated by tracing on the map with a finger. Alternatively, an area may also be indicated by touching two points on the touch screen, or an area can also be indicated by touching three or more points.

(7) It may also be arranged that other than a facility icon, characters superimposed on the road among those displayed on the map are displayed translucent or blinking. The user can thus recognize the characters displayed on the map and a portion of the road in which the characters are superimposed.

(8) Although in the above the case in which the present invention is applied to a navigation device was explained, the present invention can also be applied to a map display device not having a navigation function. For example, the present invention can also be applied to a mobile phone with a map display function, a handheld game console with a map display function, or the like.

(9) The present invention is also applied to a map display method, not limited to a map display device. A map display method according to the present invention includes a first step in which a map is displayed on a display monitor and a facility icon is displayed being superimposed on the map, a second step in which a portion of the area of the map displayed on the display monitor is indicated, a third step in which a facility icon (hereinafter, a specific facility icon) existing in the area indicated in the second step is specified from among the facility icons displayed on the display monitor, and a fourth step in which, when the facility icon is specified in the third step, the display mode of the specific facility icon is changed into a display mode in which the visibility of image information on the map is not disturbed.

In the first step of the map display method, facility icons are displayed in a display mode in which the superimposed facility icons on the map mask the portions of the map, and, in the fourth step, specific facility icons are displayed in a display mode in which the map portions where those facility icons are superimposed can be identified.

In addition, the map display method further includes a step in which a superimposed facility icon on a road of the map and a facility icon that is superimposed thereon are discriminated among the specific facility icons. In the fourth step, among the specific facility icons, only the facility icons superimposed on the road are displayed in a display mode in which map portions superimposed with the facility icons can be identified.

(10) It is also possible to install the control program of the navigation device 1 on a personal computer so as to achieve the navigation device on the personal computer. In this case, it is possible to provide a control program that achieves the navigation device 1 via a recording medium such as a DVD, a CD-ROM, or the like, or via a data signal such as the Internet or the like. In this manner, the control program that achieves the navigation device 1 having the above characteristics may be supplied in the form of a computer program product which can be read in by a computer, in various formats, such as a recording medium, a data signal (carrier wave), or the like. In this case, it is necessary that the display screen of personal computer is provided with a touch screen.

Above it is described about the display mode of specified icons and/or specified characters, in which the specified icons and/or the specified characters are displayed either translucent, blinking, or in non-displaying. Similarly, a vehicle position mark 25a drawn on the fifth layer 25 may also be displayed translucent, blinking, or in non-displaying, when the vehicle position mark overlaps with a road of a map.

Further, when the vehicle position mark overlaps with a road of a map, other than the display modes displaying the vehicle position mark translucent, blinking, or in non-displaying, the vehicle position mark may be displayed in such a manner that the only the outline of the vehicle position mark is displayed, i.e. mostly transparent, or in a manner that another more simple mark replacing the vehicle position mark, for example x or •, is displayed. Or, even further, such a mark, an outline of the vehicle position mark, or a simplified mark replacing the vehicle position mark, may be displayed in a mode that it is periodically alternating with the original vehicle position mark

It is to be noted it is possible to combine the embodiment and one or more of the variations. It is also possible to combine variations in any manner.

The above explanation is merely an example, and the invention is not limited to the above embodiment. Therefore, the map display device according to the present invention can also be configured as follows. Namely, the map display device may be configured to include a map display control unit that causes a map to be displayed on a display monitor and causes facility icons to be displayed being superimposed on the map, an indication unit that indicates a portion of an area of the map displayed on the display monitor, a specification unit that specifies a facility icon (hereinafter, a specific facility icon) existing in the area indicated by the indication unit from among the facility icons displayed on the display monitor, and a changer that changes the display mode of the specific facility icon when a facility icon is specified by the specification unit.

In addition, the map display device according to the present invention can also be configured as follows. Namely, the map display device may be configured to include a map display control unit that causes a map to be displayed on a display monitor and causes facility icons to be displayed being superimposed on the map, an indication unit that indicates a portion of an area of the map displayed on the display monitor, a specification unit that specifies a facility icon (hereinafter, a specific facility icon) existing in the area indicated by the indication unit from among the facility icons displayed on the display monitor, and a changer that changes the display mode of the specific facility icon to be different from the display mode of a facility icon outside of the area when a facility icon is specified by the specification unit.

What is claimed is:

1. A map display device, comprising:
a map display control unit that causes a map to be displayed on a display monitor and causes a facility icon to be displayed being superimposed on a map;
an indication unit that indicates a portion of an area of a map displayed on the display monitor;
a specification unit that specifies a facility icon existing in an indicated area indicated by the indication unit from among facility icons displayed on the display monitor; and
a changer that changes a display mode of a specified facility icon specified by the specification unit into a display mode in which a visibility of image information on a map is not disturbed.

2. A map display device according to claim 1, wherein:
until the indicated area is indicated by the indication unit, the map display control unit causes a facility icon displayed on the display monitor to be displayed in a display mode in which the facility icon masks a map.

3. A map display device according to claim 1, wherein:
a display mode of the specified facility icon is any of a mode in which the specified facility icon is displayed translucent, a mode in which the specified facility icon is displayed blinking, and a mode in which the facility icon is hidden.

4. A map display device according to claim 1, further comprising:
an icon discriminator that discriminates a facility icon that overlaps with a road of a map from a facility icon that does not overlap therewith among the specified facility icons, wherein:
the changer changes a display mode only of a facility icon that overlaps with a road among the specified facility icons into a display mode in which a road superimposed with the facility icon can be identified.

5. A map display device according to claim 4, wherein:
based upon a size of the specified facility icon, a distance from the specified facility icon to a neighborhood road, and a scale of a map displayed on the display monitor, the icon discriminator distinguishes whether the specified facility icon overlaps with the road.

6. A map display device according to claim 1, comprising:
a touch screen that is built into the display monitor;
a map scrolling unit that, when a touch screen on the display monitor is pressed, scrolls a map in a touch scroll mode in which a map is scrolled so that the pressed position becomes a center of a screen, and
a disable instruction output unit that outputs an instruction to disable an operation of the map scrolling unit, wherein:
the indication unit sets the indicated area based upon a position touched on the touch screen while a disable instruction is being output from the disable instruction output unit.

7. A map display device according to claim 1, comprising:
a character discriminator that discriminates a character that overlaps with the road of a map from a character that does not overlap therewith among characters displayed in the designated area; and
a character display control unit that causes the character that overlaps with the road of a map to be displayed in a display mode in which a road that is superimposed with the character can be identified when a character is displayed being superimposed on the map.

8. A map display device according to claim 7, wherein:
a display mode of the character that overlaps with the road is any of a mode in which the character overlapping with the road is displayed translucent, a mode in which the character overlapping with the road is displayed blinking, and a mode in which the character overlapping with the road is hidden.

9. A map display device according to claim 1, wherein:
when any position on a map displayed on the display monitor is indicated by a user, the indication unit indicates a predetermined range around the position as the indicated area.

10. A map display method, comprising:
a first step in which a map is displayed on a display monitor and a facility icon is displayed being superimposed on a map;
a second step in which a part of an area of a map displayed on the display monitor is indicated;
a third step in which a facility icon existing in an area indicated in the second step is specified from among facility icons displayed on the display monitor; and
a fourth step in which, a display mode of the specified facility icon specified in the third step is changed into a display mode in which a visibility of image information on a map is not disturbed.

11. A map display method according to claim 10, wherein:
in the first step, the facility icon is displayed in a display mode in which a map portion that is superimposed with the facility icon is hidden; and
in the fourth step, the specified facility icon is displayed in a display mode in which a map that is superimposed with the specified facility icon can be identified.

12. A map display method according to claim 10, further comprising:
a step in which a facility icon that overlaps with a road of a map and a facility icon that does not overlap therewith are discriminated among the specified facility icons, wherein:
in the fourth step, among the specified facility icons, only a facility icon that is superimposed on a road is displayed in a display mode in which a map that is superimposed with the facility icon can be identified.
